(19) United States
(12) Patent Application Publication
(10) Pub. No.: US 2015/0323178 A1
(43) Pub. Date: Nov. 12, 2015

(54) ARRANGEMENT AND METHOD IN ELECTRIC FILTER

(71) Applicant: Valmet Technologies Oy, Espoo (FI)

(72) Inventor: Juha Tolvanen, Tampere (FI)

(73) Assignee: Valmet Technologies Oy, Espoo (FI)

(21) Appl. No.: 14/410,646

(22) PCT Filed: Jun. 26, 2013
(86) PCT No.: PCT/FI2013/050700

§ 371 Date: Dec. 23, 2014

(30) Foreign Application Priority Data
Jun. 28, 2012 (FI) 20125741

(51) Int. Cl. F23J 15/02; B03C 3/80; B03C 3/70

(52) U.S. Cl. CPC F23J 15/025; B03C 3/70; B03C 3/80

(57) ABSTRACT

An arrangement and method in connection with an electric filter of a boiler plant, the electric filter comprising an insulator chamber. The arrangement comprises a first scavenging duct for conveying warm scavenging gas to the insulator chamber. Said first scavenging duct is connected to a channel conveying process gas in the boiler plant, which means that it is possible to supply process gas to the insulator chamber.

### BACKGROUND

The invention relates to an arrangement in connection with an electric filter of a boiler plant, the electric filter comprising an insulator chamber and a first scavenging duct for conveying warm scavenging gas to the insulator chamber.

The invention further relates to a method in connection with an electric filter of a boiler plant, the electric filter comprising an insulator chamber and a first scavenging duct for conveying warm scavenging gas to the insulator chamber.

Electric filters are used, among other things, in removing particles from flue gases.

In the insulator chambers of electric filters, warm air scavenging is used as sealing air to protect electric insulators from dust and condensate. Scavenging air is heated with an electric heater to the required temperature that is 140° C., for example.

As the price of electricity increases, the costs of warm air scavenging have become a problem.

### BRIEF DESCRIPTION

The arrangement and method of the invention are characterised by what is disclosed in the characterising parts of the independent claims. Other embodiments of the invention are characterised by what is disclosed in the other claims.

Inventive embodiments are also disclosed in the specification and drawings of this application. The inventive contents of the application may also be defined in ways other than those described in the following claims. The inventive contents may also consist of several separate inventions, particularly if the invention is examined in the light of expressed or implicit sub-tasks or in view of obtained benefits or benefit groups. In such a case, some of the definitions contained in the following claims may be unnecessary in view of the separate inventive ideas. Features of the different embodiments of the invention may be applied to other embodiments within the scope of the basic inventive idea.

In the following, features of some embodiments of the invention are listed in a random order:

The insulator chamber of the electric filter is connected through the first scavenging duct to a channel conveying process gas in the boiler plant, which means that process gas can be supplied to the insulator chamber. The advantage is that the scavenging gas of the insulator chamber need not be separately heated.

The idea of an embodiment is that the process gas is secondary, tertiary or some other corresponding air of the boiler plant. The advantage is that at least one of the above-mentioned airs is at a temperature suitable for scavenging gas.

The idea of an embodiment is that the temperature of the process gas is in the range of 80 to 300° C. The advantage is that process gas need not be heated before it is fed into the insulator chamber.

The idea of an embodiment is that the arrangement comprises a heating device and a second scavenging duct that is connected between the heating device and insulator chamber, whereby the gas heated with the heating device can be conveyed to the insulator chamber as scavenging gas, and the second scavenging duct is connected to the insulator chamber through a valve arrangement arranged to open and close it. The advantage is that it is possible to supply gas heated with the heating device to the insulator chamber during the start-up phase of the boiler plant or some other phase when the boiler plant cannot provide suitably heated scavenging gas.

The idea of an embodiment is that the valve arrangement comprises a three-way valve which is arranged in the first scavenging duct with its third connection connected to a second scavenging duct, and the valve arrangement comprises control means for controlling said three-way valve and for changing the scavenging gas supply from the first scavenging duct to the second scavenging duct and vice versa. The advantage is that the source of the scavenging gas can be changed with simple and reliable means.

The idea of an embodiment is that during the start-up phase of a boiler plant, scavenging gas is supplied to the insulator chamber through a heating device and second scavenging duct, and after the boiler plant has reached its normal operation, the process gas of the boiler plant is changed to be the scavenging gas supplied to the insulator chamber. The advantage is that good-quality scavenging gas can be supplied to the insulator chamber.

### BRIEF DESCRIPTION OF THE FIGURES

The arrangement and method are described in greater detail in the attached drawings, in which

FIG. 1 is a schematic view of an arrangement and method, and

FIG. 2 is a schematic view of a second arrangement and method.

In the figures, the matter is shown simplified for the sake of clarity. Like reference numerals identify like elements in the figures.

### DETAILED DESCRIPTION

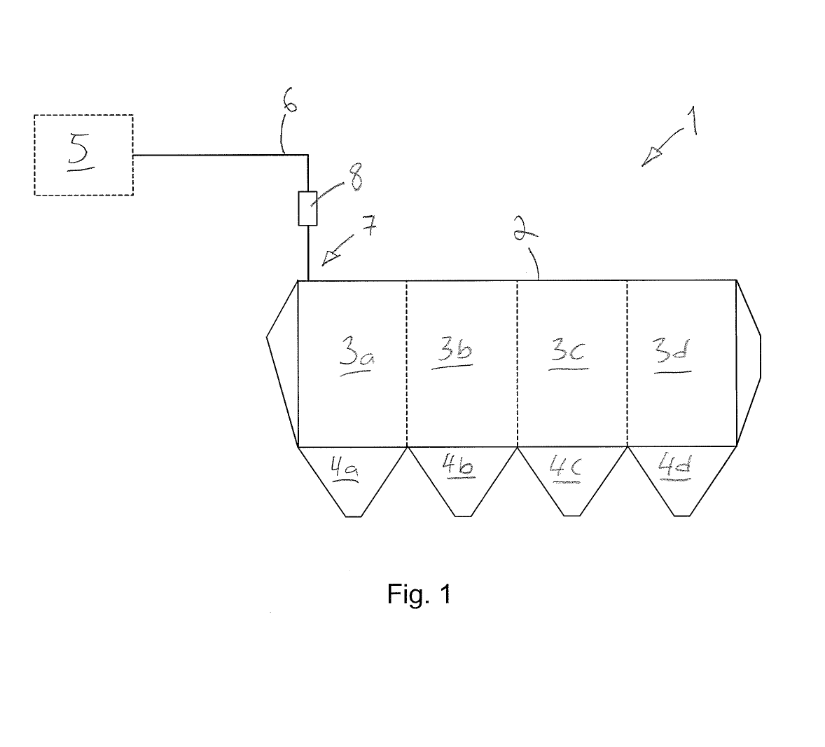

FIG. 1 is a schematic view of an arrangement and method.

An electric filter 1 known per se comprises an insulator chamber 2, which in this case is divided into four fields 3a, 3b, 3c, 3d. Each field 3a to 3d has a bottom funnel 4a to 4d, through which solid matter removed from the flue gases is removed from the insulator chambers 2.

The electric filter 1 comprises numerous components and elements, such as electric isolators, supports, shakers, pressure transmitters that are not shown in the figures to simplify the presentation.

The task of the electric filter 1 is to purify the flue and product gases created as a result of a thermal process. In this context, the thermal process refers to the processing of fuel in a boiler plant by combustion, gasification or pyrolysis, for instance.

The boiler plant 5 may comprise one or more soda recovery boilers, bubbling fluidised-bed boilers (BFB), circulating fluidised-bed boilers (CFB), gas plants, pyrolysis plants, grate boilers or the like.

Process air or gas is used in the operation of the boiler plant 5. In this specification, the term process air is used later for process air and process gas.

Process air may be secondary or tertiary air or some other air needed in the combustion process of the boiler plant, for instance.

The arrangement comprises a first scavenging duct 6, through which suitable process air is fed as scavenging air into the insulator chamber 2. The scavenging duct 6 may be an element formed of a metal pipe or duct known per se. It may comprise a thermal insulation layer, for instance.

The first scavenging duct 6 is connected to the channel or chamber conveying the process air of the boiler plant 5. It should be noted that the connection between the scavenging duct 6 and the channel or chamber conveying the process air of the boiler plant 5 is not shown in the figures.

The first scavenging duct 6 is connected through a scavenging connection 7 to the insulator chamber 2. The temperature of the air conveyed as scavenging air to the insulator chamber 2 is preferably 80 to 300° C. The duct or chamber conveying the process air of the boiler plant 5, to which the first scavenging duct 6 is connected, preferably contains process air at a temperature within said temperature range.

The process air of one and the same boiler plant 5 can also be supplied to several insulator chambers 2. The first scavenging duct 6 could be constructed in such a manner, for instance, that is branches into several insulator chambers 5.

Measures that affect its characteristics can be directed to the air to be conveyed as scavenging air. For this purpose, the first scavenging duct 6 may comprise one or more regulating elements 8 of the scavenging duct. Such a regulating element may be a closing valve, for instance, with which the scavenging duct 6 can be closed, a regulating valve or damper or some other corresponding element for adjusting the flow rate or pressure of the scavenging air.

One advantage of the arrangement and method shown in FIG. 1 is that the process air need not, at least to a significant extent, be heated before it is fed into the insulator chamber 2, which means savings in energy costs. Another advantage is that the cost of implementing the arrangement and method is small.

The proportion of scavenging air in the process air of the boiler plant 5 is insignificant. The pressure of the process air in the boiler plant 5 is typically so high that a pressure-increasing pump need not necessarily be connected to the first scavenging duct 6.

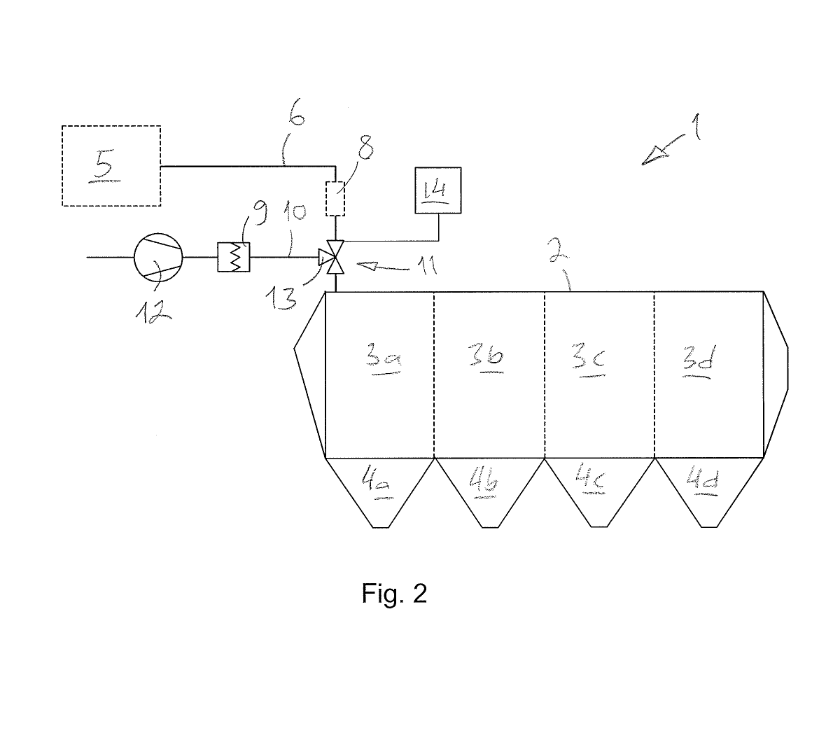

FIG. 2 is a schematic representation of a second arrangement and method that differs from that shown in FIG. 1 mainly in that the arrangement comprises a heating device 9 that is connected to the insulator chamber 6 through a second scavenging duct 10 and valve arrangement 11. The heating device 9 is an electrically operated heating device, for example.

It is possible to connect to the second scavenging duct 10 a fan 12 that supplies air to the insulator chamber 6 through the heating device 9, second scavenging duct 10 and valve arrangement 11. The fan pressurises the air into a pressure of approximately 3000 Pa, for instance, and the heating device 9 heats it to a temperature of approximately 140° C., for instance.

The valve arrangement 11 is arranged to open and close the second scavenging duct 10 to the insulator chamber 2. In the embodiment shown in FIG. 2, the valve arrangement 11 comprises a three-way valve arranged in the first scavenging duct 6.

The second scavenging duct 10 is connected to the third connection 13 of the three-way valve. By adjusting the three-way valve, it is possible to change the source of scavenging air between the air arriving from the boiler plant 5 through the first scavenging duct 6 and the air arriving from the heating device through the second scavenging duct 10.

To control its operation, the valve arrangement 11 is equipped with control means 14.

During the start-up of the boiler plant 5, that is, before it has reached its normal operating status, process air suitable for scavenging air is not necessarily available. According to an idea, the control means 14 are arranged to control the valve arrangement 11 so that during the start-up phase of the boiler plant 5, scavenging air heated by the heating device 9 is fed to the insulator chamber 2 from the second scavenging duct 10. After the boiler plant 5 has reached its normal drift, process air of the boiler plant from the first scavenging duct is changed to be the scavenging air fed to the insulator chamber 2. The heating device 9 and fan 12 are then most preferably shut down to minimize their energy consumption.

An advantage of the arrangement and method shown in FIG. 2 is, among other things, that the supply of scavenging air of suitable quality can be assured in all phases regardless of the status of the boiler plant 5 and that the consumption of electricity can be decreased to a significant extent.

In some cases, features disclosed in this application may be used as such, regardless of other features. On the other hand, when necessary, features disclosed in this application may be combined in order to provide various combinations.

In summary, the arrangement of the invention is characterised in that:

said first scavenging duct is connected to a channel conveying process gas in the boiler plant, which means that process gas can be supplied to the insulator chamber. Further, the method of the invention is characterised by conveying process gas of the boiler plant to the insulator chamber for use as scavenging gas.

The drawings and the related description are only intended to illustrate the idea of the invention. It is apparent to a person skilled in the art that the invention is not restricted to the embodiments described above, in which the invention is described by means of some examples, but many modifications and different embodiments of the invention are possible within the scope of the inventive idea defined in the following claims.

### REFERENCE NUMERALS

1 electric filter
2 insulator chamber
3a to d field
4a to d bottom funnel
5 boiler plant
6 first scavenging duct
7 scavenging connection
8 regulating elements of the scavenging duct
9 heating device
10 second scavenging duct
11 valve arrangement
12 fan
13 third connection
14 valve control means

1-10. (canceled)

11. An arrangement in connection with an electric filter of a boiler plant, the electric filter comprising:
an insulator chamber,
a first scavenging duct for conveying warm scavenging gas to the insulator chamber,
said first scavenging duct is connected to a channel conveying process gas in the boiler plant, which means that process gas is supplied to the insulator chamber,
said process gas being secondary, tertiary or some other corre-sponding air of the boiler plant.

12. An arrangement as claimed in claim 11, wherein the boiler plant is one of the following:
soda recovery boiler,
bubbling fluidised-bed boiler,
circulating fluidised-bed boiler,
gas plant,
pyrolysis plant,
grate boiler.

12. An arrangement as claimed in claim 11, wherein the temperature of the process gas is in the range of 80 to 300° C.

14. An arrangement as claimed in claim 12, wherein the temperature of the process gas is in the range of 80 to 300° C.

15. An arrangement of claim 11, comprising:
a heating device,
a second scavenging duct that is connected between the heating device and insulator chamber, whereby gas heated by the heating device is supplied to the insulator chamber as scavenging gas,
the second scavenging duct being connected to the insulator chamber through a valve arrangement arranged to open and close it.

16. An arrangement as claimed in claim 15, wherein the valve arrangement comprises:
a three-way valve arranged in the first scavenging duct with its third connection being connected to the second scavenging duct, and that
the valve arrangement comprises control means for controlling said three-way valve and for changing the scavenging gas supply from the first scavenging duct to the second scavenging duct and vice versa.

17. A method in connection with an electric filter of a boiler plant, the electric filter comprising:
an insulator chamber,
a first scavenging duct for conveying warm scavenging gas to the insulator chamber, the method comprising
conveying process gas of the boiler plant to the insulator chamber for use as scavenging gas, and
conveying secondary, tertiary or some other corresponding air of the boiler plant as the scavenging gas.

18. A method as claimed in claim 17, comprising conveying process gas as scavenging gas from one of the following boiler plants:
soda recovery boiler,
bubbling fluidised-bed boiler,
circulating fluidised-bed boiler,
gas plant,
pyrolysis plant,
grate boiler.

19. A method as claimed in claim 17, comprising conveying gas at a temperature in the range of 80 to 300° C. as the scavenging gas.

20. A method as claimed in claim 18, comprising conveying gas at a temperature in the range of 80 to 300° C. as the scavenging gas.

21. A method as claimed in claim 17, comprising feeding scavenging gas to the insulator chamber through the heating device and second scavenging duct during the start-up phase of the boiler plant, and
after the boiler plant reaches its normal drift, changing process gas of the boiler plant to be the scavenging gas fed to the insulator chamber.

22. A method as claimed in claim 21, comprising conveying the scavenging gas to the insulator chamber through a three-way valve arranged in the first scavenging duct with its third connection being connected to the second scavenging duct, and
controlling said three-way valve to change the scavenging air supply from the first scavenging duct to the second scavenging duct and vice versa.
